(19) United States
(12) Patent Application Publication
(10) Pub. No.: US 2022/0129886 A1
(43) Pub. Date: Apr. 28, 2022

(54) SYSTEM AND METHOD FOR ISOLATED MANAGEMENT OF DIGITAL ASSETS

(71) Applicant: Xiaonan Du, Beijing (CN)

(72) Inventor: Xiaonan Du, Beijing (CN)

(21) Appl. No.: 17/050,909

(22) PCT Filed: Jan. 6, 2020
(86) PCT No.: PCT/CN2020/070536

§ 371 Date: Oct. 27, 2020

(30) Foreign Application Priority Data
Dec. 13, 2019 (CN) 201911290904.1
Dec. 23, 2019 (CN) 201911341614.5
Dec. 23, 2019 (CN) 201911342711.6
Dec. 23, 2019 (CN) 201911345174.0

(51) Int. Cl. G06Q 20/38; G06Q 20/36; H04L 9/08; H04L 9/32

(52) U.S. Cl. CPC G06Q 20/385; G06Q 20/3829; G06Q 20/3825; G06Q 20/367; G06Q 2220/00; H04L 9/0894; H04L 9/3228; H04L 2209/56; H04L 9/0825

(57) ABSTRACT

A system for isolated management of digital assets is disclosed which including a financial management server communicating with an external network, a management server communicating with the financial management server through a first communication channel, a key server communicating with the management server through a second communication channel, and a first offline encryption machine communicating with the key server through a third communication channel. A method for isolated management of digital assets is further disclosed. By implementing the system and method for isolated management of digital assets, the private key is stored in the offline encryption machine and the signature is also carried out in the offline encryption machine, such that the key security can be guaranteed. In additional, the system is isolated through the multi-layer network isolation, the defects of being vulnerable to network attacks, having greater security risks and information leakage risks, can be avoided.

### TECHNICAL FIELD

The present disclosure relates generally to digital assets management field, and more particularly relates to a system and method for isolated management of digital assets

### BACKGROUND

Digital assets refer to the non-monetary assets owned or controlled by enterprises or individuals in the form of electronic data and held for sale in the daily activities or in the production process, such as the software, firmware, executable instructions, digital certificate (such as the public key certificate), password key, Bitcoin of the computer equipment. These digital assets are usually stored in some isolated management platform of digital assets.

Due to the high value of digital assets, many hackers use various technical means to attack the isolated management platform of digital assets, so as to steal the digital assets. However, the existing isolated management platform of digital assets is vulnerable to the network attacks and has greater security risks and information leakage risks.

### SUMMARY

The object of the present disclosure is to provide a system and method for isolated management of digital assets which can protect the key safely and efficiently, so as to ensure the security of digital assets, aiming at the above problem that the existing isolated management platform of digital assets is vulnerable to the network attacks and has greater security risks and information leakage risks.

In a first aspect, a system for isolated management of digital assets is provided, which comprising a financial management server communicating with an external network, a management server communicating with the financial management server through a first communication channel, a key server communicating with the management server through a second communication channel, and a first offline encryption machine communicating with the key server through a third communication channel;

wherein the financial management server receives a key application and transmits the key application to the key server through the management server, the key server generates a key and transmits the key to the first offline encryption machine; wherein the first offline encryption machine encrypts the key to generate an encrypted private key and a public key, stores the encrypted private key internally and returns the public key to the key server which further returns the public key to the financial management server along an original path.

Advantageously, the financial management server receives a transaction data to be signed and transmits it to the key server through the management server; the key server encrypts the transaction data to be signed with the public key and transmits encrypted data to the first offline encryption machine, wherein the first offline encryption machine signs the encrypted data with the encrypted private key and then returns a signature data to the key server which returns the signature data to the financial management server along the original path.

Advantageously, the third communication channel includes a first acoustic transceiver arranged on the key server and a second acoustic transceiver arranged on the first offline encryption machine; wherein the first acoustic transceiver is connected with the key server through a USB interface, and the second acoustic transceiver is connected with the first offline encryption machine through a USB interface.

Advantageously, the third communication channel includes a first QR code scanning communication device arranged on the key server and a second QR code scanning communication device arranged on the first offline encryption machine, wherein the first QR code scanning communication device is communicated with the key server through a USB interface, and the second QR code scanning communication device is communicated with the first offline encryption machine through a USB interface; wherein each QR code scanning communication device comprises a scanning unit and a display unit respectively.

Advantageously, the financial management server receives the transaction data to be signed from an external network and transmits it to the key server through the management server; the key server transmits the transaction data to be signed to the second acoustic transceiver corresponding to the first offline encryption machine through the first acoustic transceiver; wherein the first offline encryption machine encodes the transaction data to be signed to obtain a QR code and then encrypts obtained QR code with the public key and displays encrypted QR code on its corresponding display unit, the second offline encryption machine scans the encrypted QR code to obtain the transaction data through its corresponding scanning unit and signs the transaction data with the encrypted private key, then encodes signature data to obtain a signature QR code and displays the signature QR code on its corresponding display unit; the first offline encryption machine scans the signature QR code through its corresponding scanning unit to obtain the signature data and transmits the signature data through the second acoustic transceiver; wherein the key server receives the signature data through the first acoustic transceiver and returns the signature data to the financial management server along the original path.

Advantageously, the system for isolated management of digital assets comprises a plurality of first offline encryption machines, wherein the financial management server receives a key application and transmits the key application to the key server through the management server, the key server generates a key and transmits the key to each first offline encryption machine; wherein each first offline encryption machine encrypts the key to generate respective encrypted private key and public key, stores the respective encrypted private key internally and returns the respective public key to the key server which further returns the respective public key to the financial management server along an original path.

Advantageously, the financial management server receives a transaction data to be signed and transmits it to the key server through the management server; the management server selects at least one first offline encryption machine from the plurality of first offline encryption machines to sign the transaction data according to a scheduled rule.

Advantageously, the key server and the first offline encryption machine are arranged in a closed space and are physically separated from each other through a transparent partition; a first firewall is arranged in the first communication channel, the management server is arranged in an internal network; a second firewall is arranged in the second communication channel, and the key server is arranged in an isolated network.

Advantageously, the scanning unit is a scanner, the display unit is a liquid crystal display screen pasted with an anti-peeping film.

Advantageously, the system for isolated management of digital assets further comprises a second offline encryption machine communicating with the first offline encryption machine through a fourth communication channel.

Advantageously, the financial management server receives a key application and transmits the key application to the key server through the management server, the key server generates a key and transmits the key to the first offline encryption machine which forwards the key to the second offline encryption machine; wherein the second offline encryption machine encrypts the key to generate an encrypted private key and public key, stores the encrypted private key internally and returns the public key to the financial management server along the original path.

Advantageously, the financial management server receives a transaction data to be signed and transmits it to the key server through the management server; the key server forwards the transaction data to be signed to the first offline encryption machine which encrypts the transaction data to be signed with the public key and transmits encrypted data to the second offline encryption machine, wherein the second offline encryption machine signs the encrypted data with the encrypted private key and then returns a signature data to the financial management server along the original path.

Advantageously, the first offline encryption machine and the second offline encryption machine are arranged in a closed space and the key server is arranged outside the closed space.

Advantageously, the third communication channel includes a first acoustic transceiver arranged on the key server and a second acoustic transceiver arranged on the first offline encryption machine; wherein the first acoustic transceiver is connected with the key server through a USB interface, and the second acoustic transceiver is connected with the first offline encryption machine through a USB interface.

Advantageously, the fourth communication channel includes a first QR code scanning communication device arranged on the first offline encryption machine and a second QR code scanning communication device arranged on the second offline encryption machine, wherein the first QR code scanning communication device is communicated with the first offline encryption machine through a USB interface, and the second QR code scanning communication device is communicated with the second offline encryption machine through a USB interface; wherein each QR code scanning communication device comprises a scanning unit and a display unit respectively.

Advantageously, the financial management server receives the transaction data to be signed and transmits it to the key server through the management server; the key server transmits the transaction data to be signed to the second acoustic transceiver corresponding to the first offline encryption machine through the first acoustic transceiver; wherein the first offline encryption machine encodes the transaction data to be signed to obtain a QR code and then encrypts obtained QR code with the public key and displays encrypted QR code on its corresponding display unit, the second offline encryption machine scans the encrypted QR code to obtain the transaction data through its corresponding scanning unit and signs the transaction data with the encrypted private key, then encodes signature data to obtain a signature QR code and displays the signature QR code on its corresponding display unit; the first offline encryption machine scans the signature QR code through its corresponding scanning unit to obtain the signature data and transmits the signature data through the second acoustic transceiver; wherein the key server receives the signature data through the first acoustic transceiver and returns the signature data to the financial management server along the original path.

Advantageously, the system for isolated management of digital assets comprises a plurality of second offline encryption machines, wherein the financial management server receives a key application and transmits the key application to the key server through the management server, the key server generates a key and transmits the key to each second offline encryption machine through the first offline encryption machine; wherein each second offline encryption machine encrypts the key to generate respective encrypted private key and public key, stores the respective encrypted private key internally and returns the respective public key to the key server which further returns the respective public key to the financial management server along an original path.

Advantageously, the financial management server receives a transaction data to be signed and transmits it to the key server through the management server; the management server selects at least one second offline encryption machine from the plurality of second offline encryption machines to sign the transaction data according to a scheduled rule.

Advantageously, the system for isolated management of digital assets further comprises a wallet server and an online encryption machine; wherein the wallet server is communicating with the financial management server through the first communication channel and with the key server through the second communication channel, wherein the wallet server is further communicating with the online encryption machine at the same time;

wherein the wallet server receives a digital asset storage request and stores a first proportion of digital assets into the online encryption machine and a second proportion of digital assets into the first offline encryption machine according to a scheduled rule;

the financial management server receives a digital asset retrieval request and transmits it to the wallet server which retrieves the digital assets from the online encryption machine and/or the first offline encryption machine according to the scheduled rule and returns the digital assets to the financial management server.

Advantageously, the financial management server receives a key application and transmits the key application to the key server through the management server, the key server generates a key and transmits the key to the first offline encryption machine and the online encryption machine; wherein the online encryption machine encrypts the key to generate a first encrypted private key and a first public key, stores the first encrypted private key internally and returns the first public key to the key server and the financial management server; the first offline encryption machine encrypts the key to generate a second encrypted private key and a second public key, stores the second encrypted private key internally and returns the second public key to the key server which further returns the second public key to the financial management server.

Advantageously, the wallet server parses out a first transaction data to be signed by the online encryption machine and/or a second transaction data to be signed by the first offline encryption machine based on the digital asset retrieval request and the scheduled rule; the key server encrypts the first transaction data with the first public key and transmits a first encrypted data to the online encryption machine through the wallet server, the online encryption machine signs the first encrypted data with the first encrypted private key, and then returns generated first signature data to the wallet server which returns the first signature data to the financial management server along the original path; wherein the key server encrypts the second transaction data with the second public key and transmits a second encrypted data to the first offline encryption machine through the third communication channel, the first offline encryption machine signs the second encrypted data with the second encrypted private key and then returns a second signature data to the key server which returns the second signature data to the financial management server along the original path.

Advantageously, the system for isolated management of digital assets further comprises a wallet server and an online encryption machine; wherein the wallet server is communicating with the financial management server through the first communication channel and with the key server through the second communication channel, wherein the wallet server is further communicating with the online encryption machine at the same time;

wherein the wallet server receives a digital asset storage request and stores a first proportion of digital assets into the online encryption machine and a second proportion of digital assets into the second offline encryption machine according to a scheduled rule;

the financial management server receives a digital asset retrieval request and transmits it to the wallet server which retrieves the digital assets from the online encryption machine and/or the second offline encryption machine according to the scheduled rule and returns the digital assets to the financial management server.

Advantageously, the financial management server receives a key application and transmits the key application to the key server through the management server, the key server generates a key and transmits the key to the first offline encryption machine and the online encryption machine; wherein the online encryption machine encrypts the key to generate a first encrypted private key and a first public key, stores the first encrypted private key internally and returns the first public key to the key server and the financial management server; the first offline encryption machine forwards the key to the second offline encryption machine which encrypts the key to generate a second encrypted private key and a second public key, stores the second encrypted private key internally and returns the second public key to the first offline encryption machine, then the first offline encryption machine further returns the second public key to the financial management server.

Advantageously, the wallet server parses out a first transaction data to be signed by the online encryption machine and/or a second transaction data to be signed by the second offline encryption machine based on the digital asset retrieval request and the scheduled rule; the key server encrypts the first transaction data with the first public key and transmits a first encrypted data to the online encryption machine through the wallet server, the online encryption machine signs the first encrypted data with the first encrypted private key, and then returns generated first signature data to the wallet server which returns the first signature data to the financial management server along the original path; wherein the key server forwards the second transaction data to the first offline encryption machine which encrypts the second transaction data with the second public key and transmits a second encrypted data to the second offline encryption machine through the fourth communication channel, the second offline encryption machine signs the second encrypted data with the second encrypted private key and then returns a second signature data to the first offline encryption machine which returns the second signature data to the financial management server along the original path.

Advantageously, the wallet server firstly determines whether total digital assets stored in the online encryption machine meets the digital asset retrieval request; if yes, the digital assets are retrieved from the online encryption machine and returned to the financial management server, or lese, first digital assets are retrieved from the online encryption machine and second digital assets are retrieved from the first or second offline encryption machine and then returned to the financial management server; wherein a sum of the first digital assets and the second digital assets is greater than or equal to the digital asset retrieval request.

Advantageously, when the sum of the first digital assets and the second digital assets is greater than the digital asset retrieval request, the financial management server returns remaining digital assets to the online encryption machine for storage.

In a second aspect, a method for isolated management of digital assets is provided, which comprising steps of:

S1. constructing the system for isolated management of digital assets discussed above;

S2. completing a key application by using the system for isolated management of digital assets;

S3. completing a transaction data signature by using the system for isolated management of digital assets.

Advantageously, the method for isolated management of digital assets further comprises S4. completing a digital assets storage by using the system for isolated management of digital assets.

Advantageously, in step S3, completing a transaction data signature and retrieving the digital assets by using the system for isolated management of digital assets.

By implementing the system and method for isolated management of digital assets, the private key is stored in the offline encryption machine and the signature is also carried out in the offline encryption machine, such that the security of the key can be guaranteed. In additional, the system for isolated management of digital assets is isolated through the multi-layer network isolation, the defects of being vulnerable to network attacks, having greater security risks and information leakage risks, can be avoided. Furthermore, the key server and the first offline encryption machine can only communicate with each other through the acoustic wave and are isolated from each other, while the first offline encryption machine and the second offline encryption machine can only communicate with each other through the QR scanning, so the encryption process is complex and the security degree is high. Furthermore, the digital assets are stored in the offline encryption machine and the online encryption machine according to different proportions, which is convenient for quick access while having enhanced security. For the digital assets stored in the online encryption machine, customers can quickly access. For the digital assets stored in the offline encryption machine, the private key is stored in the offline encryption machine, and the signature is also carried out in the offline encryption machine, so the security of the digital assets is further guaranteed. Furthermore, the storage ratio and access rules of digital assets in the online and offline encryption machines can be configured flexibly and conveniently.

### BRIEF DESCRIPTION OF THE DRAWINGS

FIG. 1 is a schematic block diagram of a system for isolated management of digital assets according to a first preferred embodiment of the present disclosure.

FIG. 2 is a schematic block diagram of a system for isolated management of digital assets according to a second preferred embodiment of the present disclosure.

FIG. 3 is a schematic block diagram of a system for isolated management of digital assets according to a third preferred embodiment of the present disclosure.

FIG. 4 is a schematic block diagram of a system for isolated management of digital assets according to a fourth preferred embodiment of the present disclosure.

FIG. 5 is a schematic block diagram of a system for isolated management of digital assets according to a fifth preferred embodiment of the present disclosure.

FIG. 6 is a schematic block diagram of a third communication channel of the system for isolated management of digital assets according to a first preferred embodiment of the present disclosure.

FIG. 7 is a structural diagram of a third communication channel of the system for isolated management of digital assets according to a second preferred embodiment of the present disclosure.

FIG. 8 is a structural diagram of a third communication channel and fourth communication channel of the system for isolated management of digital assets according to a further preferred embodiment of the present disclosure.

FIG. 9 is a flowchart of a method for isolated management of digital assets according to a first preferred embodiment of the present disclosure.

FIG. 10 is a flowchart of a method for isolated management of digital assets according to a second preferred embodiment of the present disclosure.

### DETAILED DESCRIPTION OF THE PREFERRED EMBODIMENT

In order to make the purpose, technical scheme and advantages of the present disclosure clearer and more obvious, the present disclosure is further described in detail in combination with the attached drawings and embodiments. It should be understood that the specific embodiments described herein are intended to explain the present disclosure only and are not intended to limit the present disclosure.

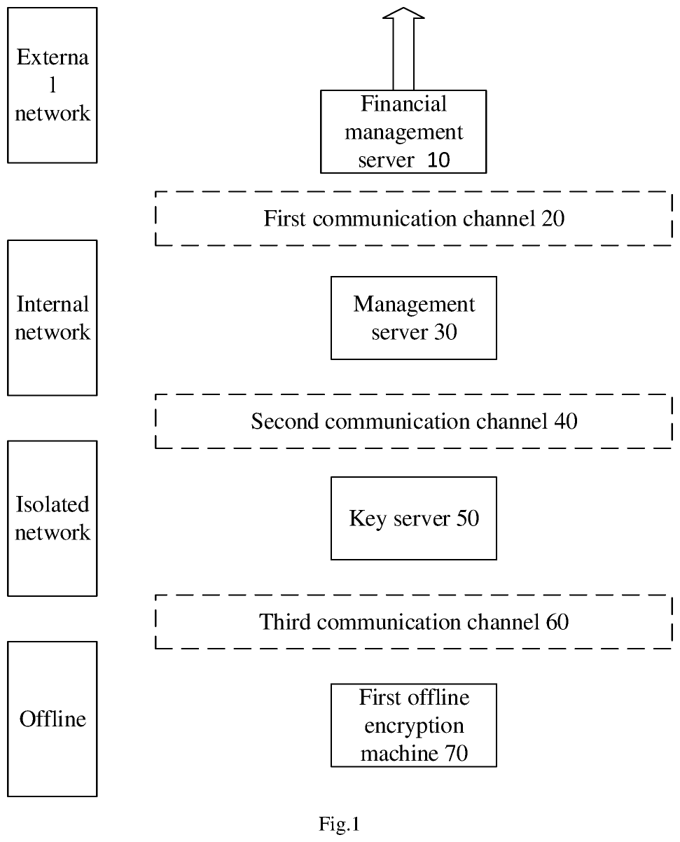

FIG. 1 is a schematic block diagram of a system for isolated management of digital assets according to a first preferred embodiment of the present disclosure. As shown in FIG. 1, the system for isolated management of digital assets comprises a financial management server 10 communicating with an external network, a management server 30 communicating with the financial management server 10 through a first communication channel 20, a key server 50 communicating with the management server 30 through a second communication channel 40, and a first offline encryption machine 70 communicating with the key server 50 through a third communication channel 60. As shown in FIG. 1, the first communication channel 20 and the second communication channel 40 are both network channels. The first communication channel 20 is arranged with a first firewall. The management server 30 is arranged in an internal network. The second communication channel 40 is arranged with a second firewall. The key server 50 is arranged in an isolated network. The key server 50 and the first offline encryption machine 70 are physically isolated in the same location. In this case, the same location means that the devices in the same location can communicate with each other by a NFC (Near Field Communication) device. In the present disclosure, “offline” means not connected to any network. The offline encryption machine means that such machine cannot communicate with an external network, and cannot communicate with other devices or equipment in any other way except for the communication mode specified herein.

In the present embodiment, the financial management server 10 receives a key application and transmits the key application to the management serves 30 arranged in the internal network. The management serves 30 transmits the key application to the key server 50 arranged in the isolated network though the second communication channel 40. The key server 50 generates a key and transmits the key to the first offline encryption machine 70. The first offline encryption machine 70 encrypts the key to generate an encrypted private key and a public key, stores the encrypted private key internally and returns the public key to the key server 50. The key server 50 returns the public key to the financial management server 10 along the original path, which can also be referred as the coming path. Since the first communication channel 20 and the second communication channel 40 are respectively provided with firewalls, the security guarantee ability can be enhanced. Furthermore, multiple layers of isolation can be achieved by isolating the external network from the internal network, isolating the internal network from the isolated network, and physically isolating the isolated network from the offline encryption machine. Moreover, the encrypted private key can only be stored in the offline encryption machine, so the security of the private key is further guaranteed and the network attacks can be avoided.

In the present embodiment, when there is transaction data to be signed, the financial management server 10 similarly receives the transaction data to be signed through the external network. Then, the transaction data to be signed is transmitted to the management server 30 in the internal network through the first communication channel 20. The management server 30 transmits the transaction data to be signed to the key server 50 in the isolated network through the second communication channel 40. The key server 50 encrypts the transaction data to be signed with the public key to obtain encrypted data and then transmits the encrypted data to the first offline encryption machine 70. The first offline encryption machine 70 signs the encrypted data with the encrypted private key stored by itself to obtain signature data, and then returns the signature data to the key server 50 which returns the signature data to the financial management server 10 along the original path. In this way, the whole signature process can only be implemented in the offline encryption machine, so the security of the private key is further guaranteed and the network attacks can be avoided. As the private key is stored in the offline encryption machine and the signature is also carried out in the offline encryption machine, such that the security of the key can be guaranteed. In additional, the system for isolated management of digital assets is isolated through the multi-layer network isolation, the defects of being vulnerable to network attacks, having greater security risks and information leakage risks, can be avoided. Furthermore, through the multi-layer firewall isolation, the security risks can further be avoided.

In a preferred embodiment, there may be a variety of signature modes. In the present embodiment, only one signature is required for each transaction data, while in the present preferred embodiment, at least one first offline encryption machine 70 may be provided. In other preferred embodiments, multiple signatures may be required for each transaction data. At this time, a plurality of first offline encryption machines 70 can be arranged. At this time, the financial management server 10 receives the key application and transmits it to the key server 50 through the management server 30. The key server 50 generates a key and transmits the key to each first offline encryption machine 70. Each first offline encryption machine 70 encrypts the key to generate respective encrypted private key and public key, stores the respective encrypted private key internally and returns the respective public key to the key server 50 which further returns the respective public key to the financial management server 10 along the original path. When a signature is required, the financial management server 10 receives the transaction data to be signed from the external network, and transmits it to the key server 50 through the management server 30. The management server 30 selects at least one of the plurality of first offline encryption machines 70 for signature, or selects two or more offline encryption machines 70 to for signature according to the scheduled rule.

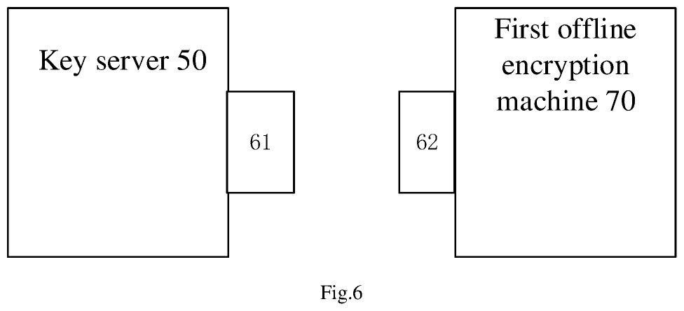

In a preferable embodiment of the present disclosure, as shown in FIG. 6, the third communication channel 60 includes a first acoustic transceiver 61 arranged on the key server 50 and a second acoustic transceiver 62 arranged on the first offline encryption machine 70; wherein the first acoustic transceiver 61 is connected with the key server 50 through a USB interface, and the second acoustic transceiver 62 is connected with the first offline encryption machine 70 through a USB interface.

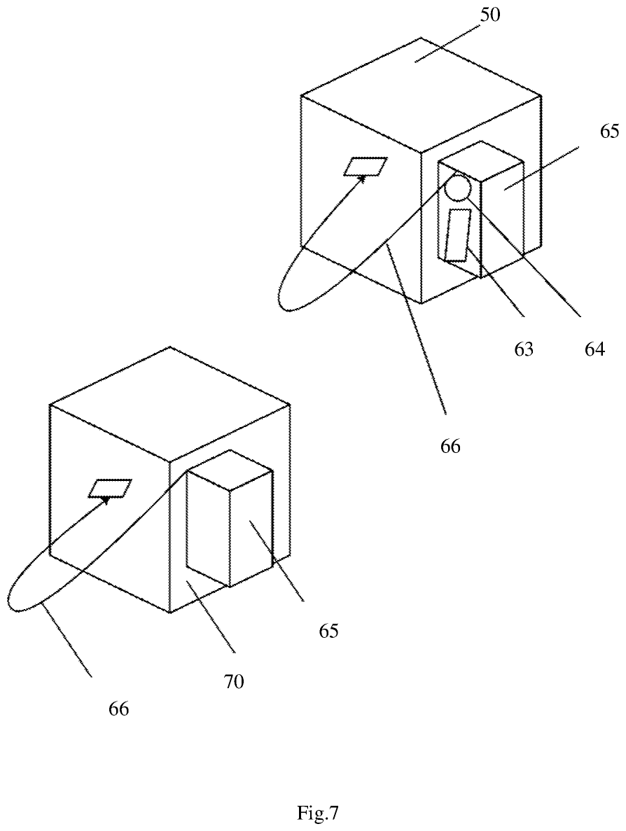

In a preferable embodiment of the present disclosure, as shown in FIG. 7, the third communication channel 60 comprises a first QR code scanning communication device arranged on the key server 50 and a second QR code scanning communication device arranged on the first offline encryption machine 70. As shown in FIG. 7, each QR code scanning communication device comprises a scanning unit 64 and a display unit 63 respectively. The scanning unit 64 and display unit 63 are mounted on the key server 50 and the first offline encryption machine 70 through a mounting base, respectively, and communicated with the key server 50 and the first offline encryption machine 70 through USB interface 66, respectively. In the present embodiment, the key server 50 and the first offline encryption machine 70 are arranged in a closed space and physically isolated by a transparent isolating plate.

Further referring FIG. 7, the scanning unit 64 and the display unit 63 are respectively located on the same side of the key server 50 and the first offline encryption machine 70, so that the scanning unit 64 of the key server 50 is facing the display unit 63 of the first offline encryption machine 70, and the display unit 63 of the key server 50 is facing the scanning unit 64 of the first offline encryption machine 70. The scanning unit 64 can be a scanning spear and the display unit 63 can be a liquid crystal display screen. The key server 50 and the first offline encryption machine 70 are arranged at locations where are physically close to each other. The scanning unit of the key server 50 is arranged to directly facing the display unit of the first offline encryption machine 70. Similarly, the display unit of the key server 50 is arranged to directly facing the scanning unit of the first offline encryption machine 70.

In this embodiment, the financial management server 10 receives the transaction data to be signed from the external network, and transmits the transaction data to the management server 30 in the internal network through the first communication channel 20. The management server 30 transmits the transaction data to be signed to the key server 50 in the isolated network through the second communication channel 40. The key server 50 encodes the transaction data to be signed to obtain a QR code and encrypts the obtained QR code with the public key, and displays the encrypted QR code on its corresponding display unit 63. In a preferred embodiment of the present disclosure, the obtained transaction data can be encoded into a QR for display by the display unit 63 using any known encoding method. Furthermore, any encryption method can be used to encrypt the obtained QR code. For example, the common DES and RSA hybrid encryption algorithm can be used. Preferably, the display of the encrypted QR code updates every scheduled time interval, for example. The first offline encryption machine 70 scans and obtains the encrypted QR code through its corresponding scanning unit 64, and then decrypts the encrypted QR code with the local encrypted private key to obtain the transaction data. Then the first offline encryption machine 70 signs the transaction data with the local encrypted private key, and encodes the signature data to obtain the signature QR code and displays the signature QR code with its corresponding display unit 63. Preferably, the scanning unit 64 can scan and obtain the signature QR code in the manner of regular polling. Of course, in another preferred embodiment of the present disclosure, the scanning unit 64 can also keep scanning all the time so as to obtain the signature QR code at the first time. The key server 50 scans and obtains the signature QR code with its corresponding scanning unit 64, and then obtains the signature data. After that the key server 50 returns the signature data to the financial management server 10 through the original path. In the present embodiment, the communication between the key server 50 and the first offline encryption machine 70 can only be achieved by the QR code scanning, so the security of the whole process is guaranteed.

In further and preferred embodiments of the present disclosure, the transaction data to be signed needs to be signed by at least two first offline encryption machines 70. The number of the first encryption machines 70 need to sign can be selected by the management server 30 according to the scheduled rule. For example, the whole system may include a plurality of offline encryption machines, and the management server 30 may select at least two or more of them to sign in turn. All signatures must be completed before the transaction can take effect. In other preferred embodiments of the disclosure, the order may not be specified. In the present embodiment, the system for isolated management of digital assets includes a plurality of first offline encryption machines 70. The key server 50 and each first offline encryption machine 70 are provided with a scanning unit 64 and a display unit 63 as the communication channel. The key server 50 and the first offline encryption machine 70 are arranged at positions which are physically relatively close to each other. The scanning unit 64 on the key server 50 is directly facing the display unit 63 on at least one of the first offline encryption machines 70. Similarly, the display unit 63 on the key server 50 is directly facing the scanning unit 64 on the at least one first offline encryption machine 70. Those skilled in the art know that the scanning unit 64 and the display unit 63 provided on the key server 50 and each first offline encryption machine 70 need to be located such that the following scanning operations can be completed. Of course, the scanning unit 64 and the display unit 63 can be adjusted manually, so as to complete different face-to-face arrangement to meet the requirements of the management server 30. The financial management server 10 receives the transaction data to be signed from the external network, and transmits it to the key server 50 through the management server 30. The management server 30 selects at least two of the plurality of first offline encryption machines for signature. The key server 50 encodes the transaction data to be signed to obtain QR code, encrypts the obtained QR code with the public key, and displays the encrypted QR code on its corresponding display unit 63. The first off-line encryption machine selected by the management server 30 firstly scans and obtains the encrypted QR code with its corresponding scanning unit 64, decrypts the encrypted QR code with the local encrypted private key to obtain the transaction data, signs the transaction data with the local encrypted private key firstly and encodes the signature data to generate a first signature QR code, and then display the first signature QR code with its corresponding display unit 63. The first off-line encryption machine selected by the management server 30 secondly scans and obtains the first signature QR code with its corresponding scanning unit 64, decrypts the first signature QR code with the local encrypted private key to obtain the transaction data, signs the transaction data with the local encrypted private key secondly and encodes the signature data to generate a second signature QR code, and then display the second signature QR code with its corresponding display unit 63. The scanning unit 64 on the key server 50 scans and obtains the second signature QR code to obtain the signature data, and returns the signature data to the financial management server 10 along the original path. In the specific password application in the present embodiment, the signature process is similar to the previous embodiment, and the difference is that two signatures are required. The security of the whole system is guaranteed by two signatures. In other preferred embodiments of the present disclosure, multiple signatures can be arranged to further increase the system security.

By implementing the system for isolated management of digital assets, the private key is stored in the offline encryption machine and the signature is also carried out in the offline encryption machine, such that the security of the key can be guaranteed. In additional, the system for isolated management of digital assets is isolated through the multi-layer network isolation, the defects of being vulnerable to network attacks, having greater security risks and information leakage risks, can be avoided. In additional, multiple signatures can be arranged to further increase the system security.

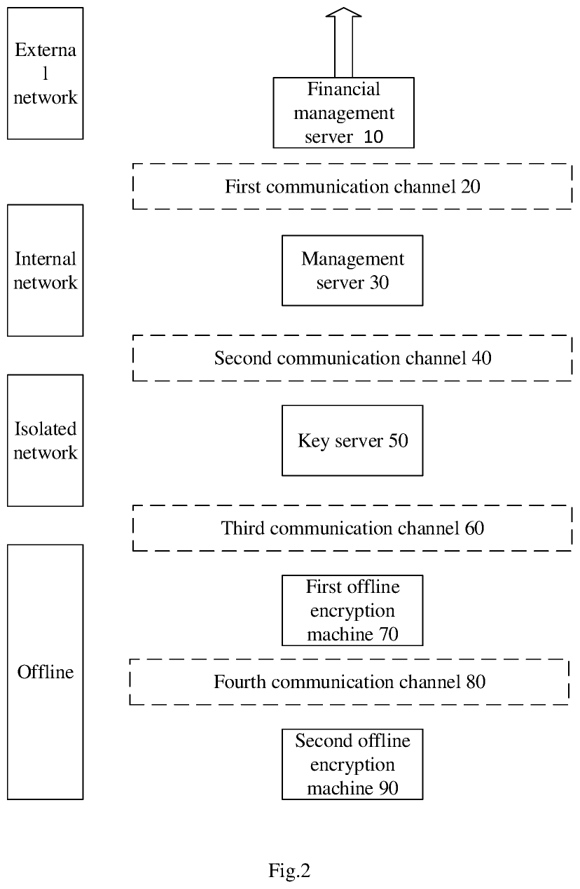

FIG. 2 is a schematic block diagram of a system for isolated management of digital assets according to a second preferred embodiment of the present disclosure. As shown in FIG. 2, the system for isolated management of digital assets comprises a financial management server 10 communicating with an external network, a management server 30 communicating with the financial management server 10 through a first communication channel 20, a key server 50 communicating with the management server 30 through a second communication channel 40, a first offline encryption machine 70 communicating with the key server 50 through a third communication channel 60, and a second offline encryption machine 90 communicating with the first offline encryption machine 70 through a fourth communication channel 80.

In the present embodiment, the financial management server 10, the first communication channel 20, the management server 30, the second communication channel 40, the key server 50, the third communication channel 60 and the first offline encryption machine 70 can all be constructed similarly according to the structures of the embodiments shown in FIG. 1. Furthermore, the fourth communication channel 80 and the second offline encryption machine 90 can be constructed with reference to the third communication channel 60 and the first offline encryption machine 70 shown in FIG. 1. Their principles are similar to the embodiment shown in FIG. 1. In this preferred embodiment, the first offline encryption machine 70, the second offline encryption machine 90 and the key server 50 are isolated from each other but are located in the same location.

During the key application process, the financial management server 10 receives a key application and transmits the key application to the management server 30 in the internal network through the first communication channel 20.

The management server 30 transmits the key application to the key server 50 located in the isolated network through the second communication channel 40. The key server 50 generates a key and transmits the key to the first offline encryption machine 70 which forwards the key to the second offline encryption machine 90 through the fourth communication channel 80. The second offline encryption machine 90 encrypts the key to generate the encrypted private key and public key, stores the encrypted private key internally and returns the public key to the financial management server 10 along the original path. Since the first communication channel 20 and the second communication channel 40 are respectively provided with firewalls, the security guarantee ability can be enhanced. Furthermore, multiple layers of isolation can be achieved by isolating the external network from the internal network, isolating the internal network from the isolated network, physically isolating the isolated network from the offline encryption machine, and isolating the first offline encryption machine from the second offline encryption machine, thus the security guarantee ability can be further enhanced. Moreover, the encrypted private key can only be stored in the offline encryption machine, so the security of the private key is further guaranteed and the network attacks can be avoided.

When there is transaction data to be signed, the financial management server 10 similarly receives the transaction data to be signed through the external network. Then, the transaction data to be signed is transmitted to the management server 30 in the internal network through the first communication channel 20. The management server 30 transmits the transaction data to be signed to the key server 50 in the isolated network through the second communication channel 40. The key server 50 forwards the transaction data to be signed to the first offline encryption machine 70 through the third communication channel 60. The first offline encryption machine 70 encrypts the transaction data to be signed with the public key to obtain encrypted data and then transmits the encrypted data to the second offline encryption machine 90. The second offline encryption machine 90 signs the encrypted data with the encrypted private key stored by itself to obtain signature data, and then returns the signature data to the key server 50 which returns the signature data to the financial management server 10 along the original path. In this way, the whole signature process can only be implemented in the offline encryption machine, so the security of the private key is further guaranteed and the network attacks can be avoided.

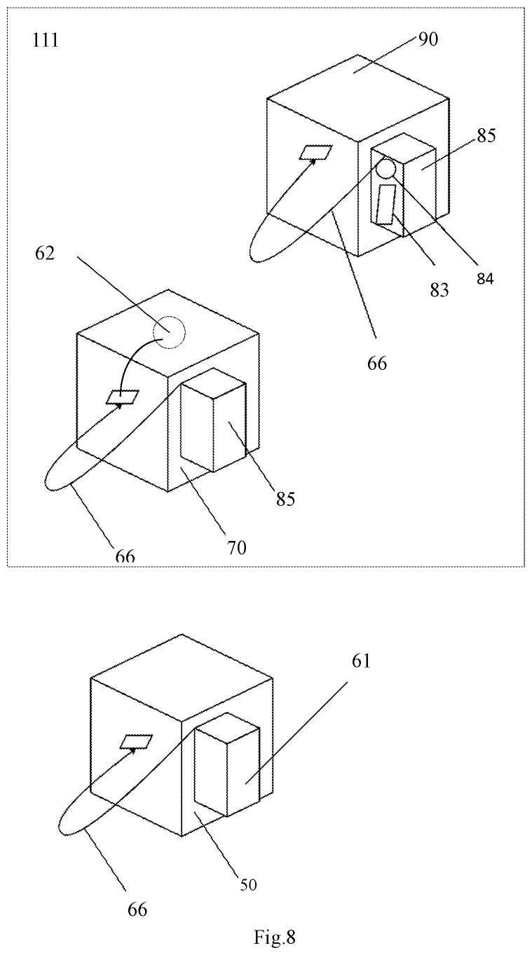

In a preferred embodiment of the disclosure, the third communication channel 60 and the fourth communication channel 80 may adopt special arrangements. FIG. 8 is a structural diagram of a third communication channel and fourth communication channel of the system for isolated management of digital assets according to a further preferred embodiment of the present disclosure. As shown in FIG. 8, the third communication channel 60 includes a first acoustic transceiver 61 arranged on the key server 50 and a second acoustic transceiver 62 arranged on the first offline encryption machine 70; wherein the first acoustic transceiver 61 is connected with the key server 50 through a USB interface 66, and the second acoustic transceiver 62 is connected with the first offline encryption machine 70 through a USB interface 66. The fourth communication channel 80 comprises a first QR code scanning communication device arranged on the first offline encryption machine 70 and a second QR code scanning communication device arranged on the second offline encryption machine 90. The first QR code scanning communication device is connected with the first offline encryption machine 70 through a USB interface. The second QR code scanning communication device is connected with the second offline encryption machine 90 through a USB interface. Each QR code scanning communication device comprises a scanning unit 84 and a display unit 83 respectively. The scanning unit 84 and display unit 83 are mounted on the key server 50 and the first offline encryption machine 70 through a mounting base 85, respectively, and communicated with the second offline encryption machine 90 and the first offline encryption machine 70 through USB interface 66, respectively. In the present embodiment, the second offline encryption machine 90 and the first offline encryption machine 70 are arranged in a closed space 111, while the key server 50 is arranged outside the closed space 111. The enclosed space 111 is preferably made of opaque and non-sound insulation materials to facilitate sound wave transmission.

During the key application process, the financial management server 10 receives a key application and transmits the key application to the management server 30 in the internal network through the first communication channel 20. The management server 30 transmits the key application to the key server 50 located in the isolated network through the second communication channel 40. The key server 50 generates a key and transmits the key to the second acoustic transceiver 62 corresponding to the first offline encryption machine 70 through the first acoustic transceiver 61. The first offline encryption machine 70 forwards the key to the second offline encryption machine 90 through the display unit 63 on the first offline encryption machine 70 and the scanning unit 64 on the second offline encryption machine 90. The second offline encryption machine 90 encrypts the key to generate the encrypted private key and public key, stores the encrypted private key internally and displays the public key on its corresponding display unit 63. The first offline encryption machine 70 scans the public key through its corresponding scanning unit 64, and returns such public key to the financial management server 10 through the second acoustic transceiver 62, the first acoustic transceiver 61, and each communication channel along the original path. In the present embodiment, the transition of the key between the offline encryption machines can be completed by the display and scanning of the QR code.

When there is transaction data to be signed, the financial management server 10 similarly receives the transaction data to be signed through the external network. Then, the transaction data to be signed is transmitted to the key server 50. The key server 50 transmits the transaction data to be signed to the second acoustic transceiver 62 corresponding to the first offline encryption machine 70 through the first acoustic transceiver 61. Similarly as taught before, the first offline encryption machine 70 encodes the transaction data to be signed to obtain the QR code, and encrypts the QR code with the public key and displays encrypted QR code on its corresponding display unit 63. The second offline encryption machine 90 scans the encrypted QR code to obtain the transaction data through its corresponding scanning unit 64 and signs the transaction data with the encrypted private key, then encodes signature data to obtain a signature QR code and displays the signature QR code on its corresponding display unit 63. The first offline encryption machine 70 scans the signature QR code through its corresponding scanning unit 64 to obtain the signature data and transmits the signature data through the second acoustic transceiver 63. The key server 50 receives the signature data through the first acoustic transceiver 61 and returns the signature data to the financial management server 10 along the original path.

In the preferable embodiment of the present disclosure, any known encoding method can be used to encode the obtained transaction data into a QR code that can be displayed by the display unit. Furthermore, any encryption method can be used to encrypt the obtained QR code. For example, the common DES and RSA hybrid encryption algorithm can be used. Preferably, the display of the encrypted QR code updates every scheduled time interval, for example. Preferably, the scanning unit can scan and obtain the signature QR code in the manner of regular polling. Of course, in another preferred embodiment of the present disclosure, the scanning unit can also keep scanning all the time so as to obtain the signature QR code at the first time. The scanning unit can be a scanning spear and the display unit can be a liquid crystal display screen pasted with an anti-peeping film. In this embodiment, the key server and the first offline encryption machine can only communicate through acoustic waves, while the first offline encryption machine and the second offline encryption machine can only communicate through QR code scanning, so the encryption process is complex and the security degree is high. Furthermore, through the multi-layer firewall isolation, the security risks can be further avoided.

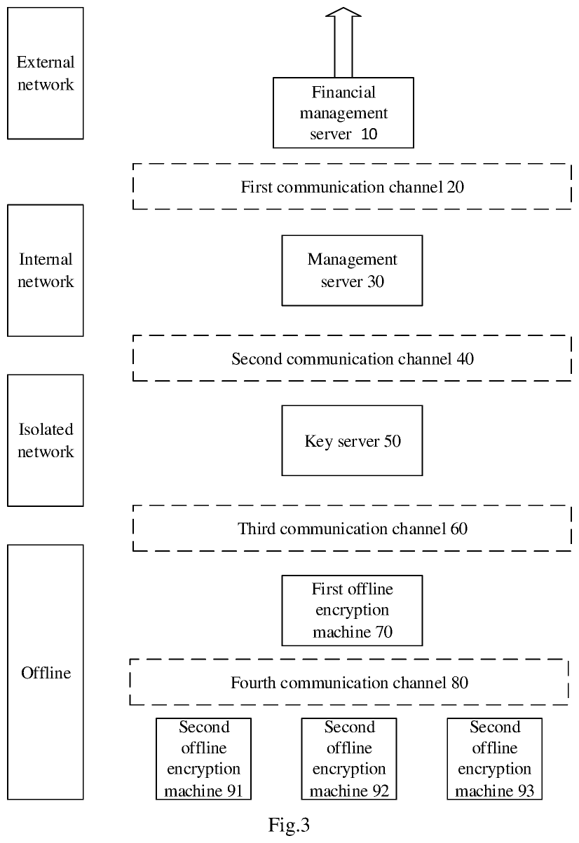

FIG. 3 is a schematic block diagram of a system for isolated management of digital assets according to a third preferred embodiment of the present disclosure. The embodiment shown in FIG. 3 is similar to FIG. 2 except that it includes a plurality of second offline encryption machines 91-93. In the present embodiment, the financial management server 10 receives a key application and transmits the key application to the key server 50 through the management server 30. The key server 50 generates a key and transmits the key to the first offline encryption machine 70 which forwards the key to each second offline encryption machine 91, 92, 93. Each second offline encryption machine 91, 92, 93 encrypts the key to generate respective encrypted private key and public key, stores the respective encrypted private key internally and returns the respective public key to the key server which further returns the respective public key to the financial management server 10 along an original path.

When there is transaction data to be signed, the financial management server 10 receives the transaction data to be signed and transmits it to the key server 50 through the management server 30. The management server 30 selects at least one second offline encryption machine from the plurality of second offline encryption machines 91, 92, 93 to sign the transaction data according to a scheduled rule. In the present embodiment, as discussed above, the scanning unit 64 and display unit 63 can be arranged on each of the second offline encryption machines 91, 92, 93. For example, the second offline encryption machines 91 and 92 may be selected for the first signature. The key server 50 forwards the transaction data to be signed to the first offline encryption machine 70, which encodes the transaction data to be signed to obtain the QR code, encrypts the obtained QR code with at least one public key, and displays the encrypted QR code on its corresponding display unit 63. Selecting which public key may be specified by the key server 50. The second offline encryption machine 91 scans the encrypted QR code with its corresponding scanning unit 64 and decrypts the encrypted QR code with the local encrypted private key to obtain the transaction data, and then signs the transaction data with the local encrypted private key, and then encodes the signature data to generate a first signature QR code, and displays the first signature QR code with its corresponding display unit 63. The second offline encryption machine 92 scans the first signature QR code with its corresponding scanning unit 64 and decrypts the first signature QR code with the local encrypted private key to obtain the transaction data, and then signs the transaction data secondly with the local encrypted private key, and then encodes the second signature data to generate a second signature QR code, and displays the second signature QR code with its corresponding display unit 63. The first offline encryption machine 70 scans the second signature QR code with its corresponding scanning unit 64 to obtain the second signature data and returns the second signature data to the financial management server 10 along the original path. One skilled in the art knows that, more number of second offline encryption machines can be arranged, and the signature time can be more. The system administrator can defines that which public key can be selected for the signature and which second offline encryption machine or second offline encryption machines can be selected according to the actual requirements. In this embodiment, the security of the transaction is further enhanced through the multi-signature transaction. In such a way, the signature will not be stolen even if there is a problem with a second offline encryption machine. In addition, the data of the second signature can be directly transmitted to the first offline encryption machine 70 through the second offline encryption machine, or returned to the first offline encryption machine 70 according to the original path. The communication between the first offline encryption machine 70 and the key server 50 can adopt acoustic wave communication or QR code communication. Based on the instruction of the present disclosure, one skilled in the art can construct various implementation modes.

By implementing the system for isolated management of digital assets, the private key is stored in the offline encryption machine and the signature is also carried out in the offline encryption machine, such that the security of the key can be guaranteed. In additional, the system for isolated management of digital assets is isolated through the multi-layer network isolation, the defects of being vulnerable to network attacks, having greater security risks and information leakage risks, can be avoided. Furthermore, the key server and the first offline encryption machine can only communicate with each other through the acoustic wave and are isolated from each other, while the first offline encryption machine and the second offline encryption machine can only communicate with each other through the QR scanning, so the encryption process is complex and the security degree is high. Furthermore, the storage ratio and access rules of digital assets in the online and offline encryption machines can be configured flexibly and conveniently.

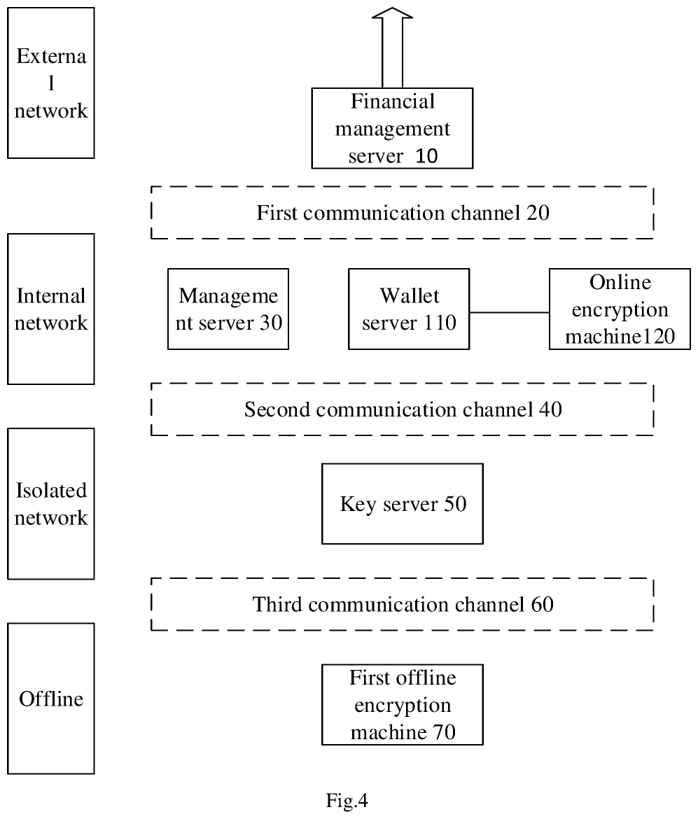

FIG. 4 is a schematic block diagram of a system for isolated management of digital assets according to a fourth preferred embodiment of the present disclosure. As shown in FIG. 4, the system for isolated management of digital assets comprises a financial management server 10 communicating with an external network, a management server 30 communicating with the financial management server 10 through a first communication channel 20, a key server 50 communicating with the management server 30 through a second communication channel 40, and a first offline encryption machine 70 communicating with the key server 50 through a third communication channel 60. Furthermore, as shown in FIG. 4, the system for isolated management of digital assets further comprises a wallet server 110 and an online encryption machine 120. The wallet server 110 is communicating with the financial management server 10 through the first communication channel 20 and with the key server 50 through the second communication channel 40, wherein the wallet server 110 is further communicating with the online encryption machine 120 at the same time.

In this preferable embodiment, regarding the financial management server 10, the first communication channel 20, the management server 30, the second communication channel 40, the key server 50, and the first offline encryption machine 70, their other functions excepted the specific function mentioned in the present embodiment, can be constructed with reference to the embodiment shown in FIG. 1. In the present embodiment, the online encryption machine 120 and the wallet server 110 can be constructed with reference to the following embodiment. Based on the present disclosure and the common knowledge, one skilled in the art can construct such online encryption machine 120 and wallet server 110. In the present disclosure, the online encryption machine 120 refers to that the encryption machine can be connected with the external network through the wallet server 110 and the financial management server 10.

In present embodiment, during the key application process, the financial management server 10 receives a key application and transmits the key application to the management serves 30 arranged in the internal network through the first communication channel 20. The management serves 30 transmits the key application to the key server 50 arranged in the isolated network though the fourth communication channel 40. The key server 50 generates a key and transmits the key to the first offline encryption machine 70 and the wallet server 110 through the third communication channel. The wallet server 110 transmits the key to the online encryption machine 120. The online encryption machine 120 encrypts the key to generate a first encrypted private key and a first public key, stores the first encrypted private key internally and returns the first public key to the wallet server 110 which returns the first public key to the key server 50 and the financial management server 10 through the second communication channel 40 and the first communication channel 20. The first offline encryption machine 70 encrypts the key to generate a second encrypted private key and a second public key, stores the second encrypted private key internally and returns the second public key to the key server 50 through the third communication channel 60. The key server 50 returns the second public key to the financial management server 10 through the second communication channel 40 and the management serves 30. Of course, the key server 50 can also return the second public key to the financial management server 10 through the second communication channel 40 and the wallet server 110.

When there are digital assets to be stored in, the financial management server 10 receives a digital asset storage request and transmits it to the wallet server 110 which stores a first proportion of digital assets into the online encryption machine 120 and a second proportion of digital assets into the first offline encryption machine 40 according to a scheduled rule. In a preferred embodiment of the present disclosure, a plurality of digital assets from various clients can be received through the financial management server 10. When a certain amount is accumulated, the financial management server 10 generates a digital asset storage request. In another preferred embodiment of the present disclosure, the financial management server 10 may also receive digital asset storage requests from various clients. Usually, a small proportion of digital assets (e.g. 5-10%) will be stored in the online encryption machine to cope with the account circulation, while a large proportion of digital assets (90-95%) will be stored in the offline encryption machine to ensure the account security. Of course, other settings can be made according to actual needs. A large proportion of digital assets (90-95%) can be stored in the first encryption machine 70 by the offline bitcoin wallet address. The storage mode of the digital asset in the first offline encryption machine 70 can also be set according to actual needs. For example, all digital assets can be written into the same bitcoin wallet address, and then multiple backup bitcoin wallet addresses can be arranged for subsequent asset retrieval operation. Or all digital assets can be written in equally or unequally amounts according to certain proportion rules to different bitcoin wallet addresses to facilitate subsequent asset retrieval operations. Each bitcoin wallet address is invalid after the digital assets are retrieved by the signature.

When the digital assets are to be retrieved, the financial management server 10 receives a digital asset retrieval request from one client or digital asset retrieval requests from multiple clients, and then transmits such request or requests to the wallet server 110 which retrieves the digital asset from the online encryption machine 120 and/or the first offline encryption machine 70 according to the scheduled rule and returns the digital assets to the financial management server 10 which then transmits such digital assets to the clients through the Blockchain. For example, if the wallet server 110 finds that the total amount of the digital assets required to be retrieved by the digital asset retrieval request is lower than the total amount of digital assets stored in the online encryption machine 120, and the remaining digital assets after the retrieval in the online encryption machine 120 will not be lower than the minimum storage amount specified by the online encryption machine 120, the digital assets can be directly retrieved from the online encryption machine 120. If the wallet server 110 finds that the total amount of the digital assets required to be retrieved by the digital asset retrieval request is lower than the total amount of digital assets stored in the online encryption machine 120, but the remaining digital assets after the retrieval in the online encryption machine 120 will be lower than the minimum storage amount specified by the online encryption machine 120, the digital assets can be directly retrieved from the online encryption machine 120 and a specific amount of digital assets would be retrieved from the first offline encryption machine 70 then or a specific time period and stored into the online encryption machine 120. Furthermore, if the wallet server 110 finds that the total amount of the digital assets required to be retrieved by the digital asset retrieval request is higher than the total amount of digital assets stored in the online encryption machine 120, the first digital assets are retrieved from the online encryption machine 120 and the second digital assets are retrieved from the first offline encryption machine 70 according to the scheduled rule (such as a certain proportion or requirement). When the sum of the first digital assets and the second digital assets is greater than the digital asset retrieval request, the financial management server 10 returns the remaining digital assets to the online encryption machine 120 for storage. Of course, in another preferable embodiment of the present disclosure, if the wallet server 110 finds that the total amount of the digital assets required to be retrieved by the digital asset retrieval request is relatively large, and the digital assets stored in the online encryption machine 120 is lower than or equal to the minimum storage amount specified by the online encryption machine 120, the digital assets can be directly retrieved from the first offline encryption machine 70. Of course, based on the teaching of the present disclosure, one skilled in the art can also configure other rules and requirements.

In a preferred embodiment of the present disclosure, when there are digital assets to be retrieved, the wallet server 80 parses out a first transaction data to be signed by the online encryption machine 120 and/or a second transaction data to be signed by the first offline encryption machine 70 based on the digital asset retrieval request and the scheduled rule. As mentioned above, when the digital assets only need to be retrieved from the online encryption machine 120, just the first transaction data is parsed out, and when the digital assets only need to be retrieved from the first offline encryption machine 70, just the second transaction data is parsed out. When the digital assets need to be retrieved from both of the online encryption machine 120 and first offline encryption machine 70, both of the first and second transaction data are parsed out.

When the first transaction data is parsed out, the key server 50 encrypts the first transaction data with the first public key, and then transmits the first encrypted data to the online encryption machine 120 through the wallet server 110, and the online encryption machine 120 signs the first encrypted data with the first encrypted private key, and then returns the generated first signature data to the wallet server 11 which further returns the first signature data to the financial management server 10 along the original path. When the second transaction data is parsed out, the key server 50 encrypts the second transaction data with the second public key, transmits the second encrypted data to the first offline encryption machine 70 through the third communication channel 60. The first offline encryption machine 70 signs the second encrypted data with the second encrypted private key, and then returns the generated second signature data to the key server 50 which returns the second signature data to the financial management server 10 along the original path. When the first and second transaction data are both parsed out at the same time, the above two steps can be performed at the same time.

In a preferred embodiment of the present disclosure, the third communication channel 60 may also adopt the embodiments shown in FIG. 6 or FIG. 7. For example, when the embodiment shown in FIG. 7 is adopted and the offline encryption machine 70 is required to sign, the key server 50 encodes the second transaction data after receiving the second transaction data to obtain QR code and encrypts the obtained QR code with the second public key, and then displays the encrypted QR code on its corresponding display unit 63. The offline encryption machine 70 scans and obtains the encrypted QR code through its corresponding scanning unit 64, and then decrypts the encrypted QR code with the second encrypted private key to obtain the second transaction data, signs the second transaction data with the second encrypted private key to obtain the second signature data, encodes the second signature data to obtain a signature QR code, and then displays the signature QR code by its corresponding display unit 63. The key server 50 scans the signature QR code with its corresponding scanning unit 64 to obtain the second signature data, and returns the second signature data to the financial management server 10 along the original path. Similarly, in the present embodiment, during the key application process, the communication between the key server 50 and the first offline encryption machine 70 is the same, which will not be repeated here.

By implementing the system for isolated management of digital assets, the digital assets are stored in the offline encryption machine and the online encryption machine according to different proportions, which is convenient for quick access while having enhanced security. For the digital assets stored in the online encryption machine, customers can quickly access. For the digital assets stored in the offline encryption machine, the private key is stored in the offline encryption machine, and the signature is also carried out in the offline encryption machine, so the security of the digital assets is further guaranteed. In additional, the system for isolated management of digital assets is isolated through the multi-layer network isolation, the defects of being vulnerable to network attacks, having greater security risks and information leakage risks, can be avoided. Furthermore, the storage ratio and access rules of digital assets in the online and offline encryption machines can be configured flexibly and conveniently.

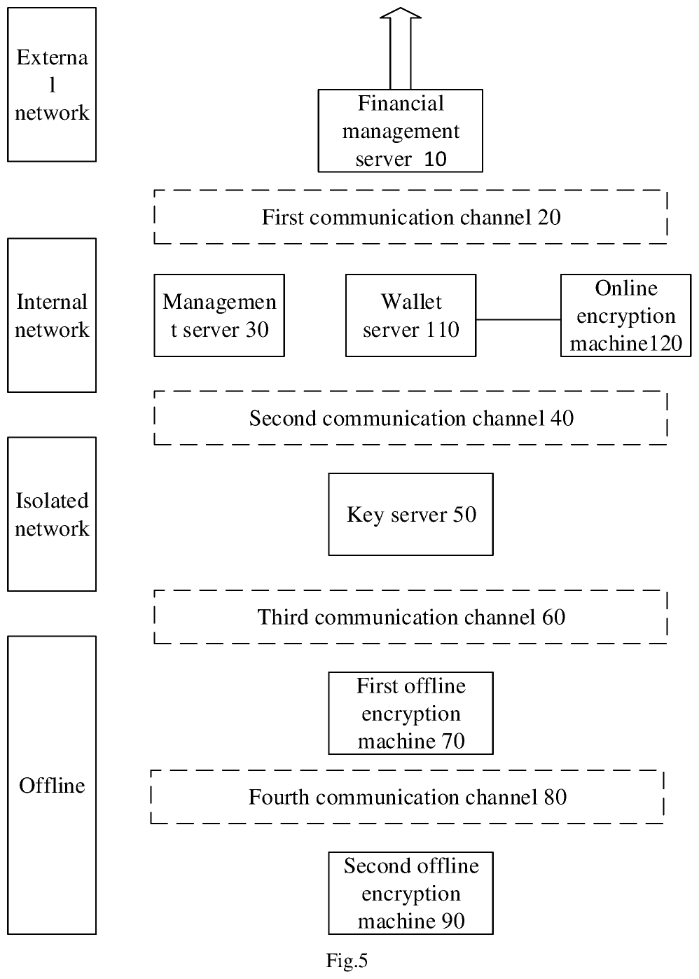

FIG. 5 is a schematic block diagram of a system for isolated management of digital assets according to a fifth preferred embodiment of the present disclosure. As shown in FIG. 5, the system for isolated management of digital assets comprises a financial management server 10 communicating with an external network, a management server 30 communicating with the financial management server 10 through a first communication channel 20, a key server 50 communicating with the management server 30 through a second communication channel 40, a first offline encryption machine 70 communicating with the key server 50 through a third communication channel 60, and a second offline encryption machine 90 communicating with the first offline encryption machine 70 through a fourth communication channel 80. Furthermore, as shown in FIG. 5, the system for isolated management of digital assets further comprises a wallet server 110 and an online encryption machine 120. The wallet server 110 is communicating with the financial management server 10 through the first communication channel 20 and with the key server 50 through the second communication channel 40, wherein the wallet server 110 is further communicating with the online encryption machine 120 at the same time.

In the present embodiment, the financial management server 10, the first communication channel 20, the management server 30, the second communication channel 40, the key server 50, the third communication channel 60 and the first offline encryption machine 70, the second offline encryption machine 90 and the fourth communication channel 80 can all be constructed similarly according to the structures of the embodiments shown in FIG. 2. Furthermore, the wallet server 110 and online encryption machine 120 be constructed according to the structures of the embodiments shown in FIG. 4. Based on the present disclosure and common knowledge, one skilled in the art can construct such devices. In a preferred embodiment of the application, a plurality of second offline encryption machines may be included.

In the present embodiment, during the key application process, the financial management server 10 receives a key application and transmits the key application to the key server 50 through the management server 30. The key server 50 generates a key and transmits the key to the first offline encryption machine 70 and the online encryption machine 120. The online encryption machine 120 encrypts the key to generate a first encrypted private key and a first public key, stores the first encrypted private key internally and returns the first public key to the key server 50 and the financial management server 10. The first offline encryption machine 70 forwards the key to the second offline encryption machine 90 which encrypts the key to generate a second encrypted private key and a second public key, stores the second encrypted private key internally and returns the second public key to the first offline encryption machine 70 which further returns the second public key to the financial management server 10 along the original path.

When the digital assets are to be retrieved, the wallet server 110 parses out a first transaction data to be signed by the online encryption machine 120 and/or a second transaction data to be signed by the first offline encryption machine 70 based on the digital asset retrieval request and the scheduled rule. The key server 50 encrypts the first transaction data with the first public key and transmits a first encrypted data to the online encryption machine 120 through the wallet server 110. The online encryption machine 120 signs the first encrypted data with the first encrypted private key, and then returns generated first signature data to the wallet server 110 which returns the first signature data to the financial management server 30 along the original path. The key server 50 forwards to the second transaction data to the first offline encryption machine 70 which encrypts the second transaction data with the second public key and transmits a second encrypted data to the second offline encryption machine 90 through the fourth communication channel 80. The second offline encryption machine 90 signs the second encrypted data with the second encrypted private key and then returns a second signature data to the first offline encryption machine 70 which returns the second signature data to the financial management server 10 along the original path.

In the system for isolated management of digital assets, the wallet server 110 firstly determines whether total digital assets stored in the online encryption machine 120 meet the digital asset retrieval request. If yes, the digital assets are retrieved from the online encryption machine 120 and returned to the financial management server 10. Or lese, the first digital assets are retrieved from the online encryption machine 120 and the second digital assets are retrieved from the first offline encryption machine 70 or the second offline encryption machine 90 and then returned to the financial management server 10. Wherein, the sum of the first digital assets and the second digital assets is greater than or equal to the digital asset retrieval request.

In the system for isolated management of digital assets, when the sum of the first digital assets and the second digital assets is greater than the digital asset retrieval request, the financial management server 10 returns remaining digital assets to the online encryption machine 120 for storage.

By implementing the system for isolated management of digital assets, the private key is stored in the offline encryption machine and the signature is also carried out in the offline encryption machine, such that the security of the key can be guaranteed. In additional, the system for isolated management of digital assets is isolated through the multi-layer network isolation, the defects of being vulnerable to network attacks, having greater security risks and information leakage risks, can be avoided. Furthermore, the digital assets are stored in the offline encryption machine and the online encryption machine according to different proportions, which is convenient for quick access while having enhanced security. For the digital assets stored in the online encryption machine, customers can quickly access. For the digital assets stored in the offline encryption machine, the private key is stored in the offline encryption machine, and the signature is also carried out in the offline encryption machine, so the security of the digital assets is further guaranteed. Furthermore, the storage ratio and access rules of digital assets in the online and offline encryption machines can be configured flexibly and conveniently.

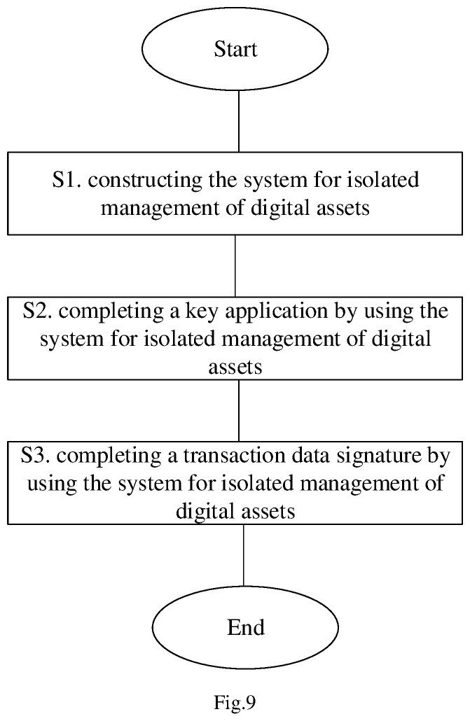

FIG. 9 is a flowchart of a method for isolated management of digital assets according to a first preferred embodiment of the present disclosure. In step S 1, the system for isolated management of digital assets discussed above is constructed. In this embodiment, the system for isolated management of digital assets can be constructed according to any embodiment shown in FIG. 1-7.

In step S2, a key application is completed by using the system for isolated management of digital assets. In a preferred embodiment of the present disclosure, the key application can be completed with reference to any steps and methods mentioned in FIGS. 1-7. For example, the financial management server receives a key application and transmits it to the key server through the management server. The key server generates a key and transmits the key to the first offline encryption machine which encrypts the key to generate an encrypted private key and public key, stores the encrypted private key internally and returns the public key to the key server which further returns the public key to the financial management server along the original path.

In step S3, a transaction data signature is completed by using the system for isolated management of digital assets. The transaction data signature can be completed by referring to any methods and steps in FIGS. 1-8. For example, the financial management server receives the transaction data to be signed from an external network and transmits it to the key server through the management server. The key server encrypts the encrypted data with the public key and transmits the encrypted data to the first offline encrypting machine. The first offline encrypting machine signs the encrypted data with the encrypted private key, and then returns the signature data to the key server which returns the signature data to the financial management server along the original path.

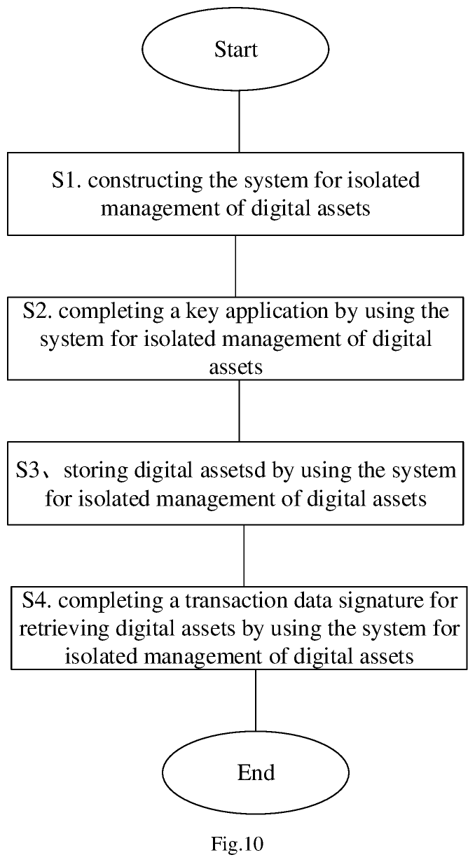

FIG. 10 is a flowchart of a method for isolated management of digital assets according to a second preferred embodiment of the present disclosure. In step S1, the system for isolated management of digital assets discussed above is constructed. In this embodiment, the system for isolated management of digital assets can be constructed according to any embodiment shown in FIG. 1-7.

In step S2, a key application is completed by using the system for isolated management of digital assets. In a preferred embodiment of the present disclosure, the key application can be completed with reference to any steps and methods mentioned in FIGS. 1-7. For example, the financial management server receives a key application and transmits it to the key server through the management server. The key server generates a key and transmits the key to the first offline encryption machine which forwards the key to the second offline encryption machine. The second offline encryption machine encrypts the key to generate an encrypted private key and public key, stores the encrypted private key internally and returns the public key to the financial management server along the original path.

In step S3, the digital assets are stored by using the system for isolated management of digital assets. For example, in a preferred embodiment of the present disclosure, the storage of digital assets can be completed with reference to any steps or methods of the above embodiments. For example, in this step, the wallet server receives a digital asset storage request and stores a first proportion of digital assets into the online encryption machine and a second proportion of digital assets into at least one of the first offline encryption machine or the second offline encryption machine according to a scheduled rule. In the preferred embodiment of the present disclosure, a plurality of the first offline encryption machines or second offline encryption machines can be arranged, and the wallet server stores digital assets in one or more offline encryption machines according to the scheduled rule. One skilled in the art know that the sequence of steps S2 and S3 can be changed as long as they are guaranteed to be implemented between steps S1 and S4.

In step S4, a transaction data signature is implemented for retrieving digital assets by using the system for isolated management of digital assets. The digital assets retrieving can be completed with reference to any steps or methods of the above embodiments. The wallet server parses out a first transaction data to be signed by the online encryption machine and/or a second transaction data to be signed by the first offline encryption machine or the second offline encryption machine based on the digital asset retrieval request and the scheduled rule. The key server encrypts the first transaction data with the first public key and transmits a first encrypted data to the online encryption machine through the wallet server, the online encryption machine signs the first encrypted data with the first encrypted private key, and then returns generated first signature data to the wallet server which returns the first signature data to the financial management server along the original path. The key server encrypts the second transaction data with the second public key and transmits a second encrypted data to the first offline encryption machine through the third communication channel, or the second offline encryption machine. The first offline encryption machine or the second offline encryption machine signs the encrypted data with the encrypted private key and then returns a signature data to the financial management server along the original path.

By implementing the method for isolated management of digital assets, the private key is stored in the offline encryption machine and the signature is also carried out in the offline encryption machine, such that the security of the key can be guaranteed. In additional, the system for isolated management of digital assets is isolated through the multi-layer network isolation, the defects of being vulnerable to network attacks, having greater security risks and information leakage risks, can be avoided. Furthermore, the key server and the first offline encryption machine can only communicate with each other through the acoustic wave and are isolated from each other, while the first offline encryption machine and the second offline encryption machine can only communicate with each other through the QR scanning, so the encryption process is complex and the security degree is high. Furthermore, the digital assets are stored in the offline encryption machine and the online encryption machine according to different proportions, which is convenient for quick access while having enhanced security. For the digital assets stored in the online encryption machine, customers can quickly access. For the digital assets stored in the offline encryption machine, the private key is stored in the offline encryption machine, and the signature is also carried out in the offline encryption machine, so the security of the digital assets is further guaranteed. Furthermore, the storage ratio and access rules of digital assets in the online and offline encryption machines can be configured flexibly and conveniently.

Therefore, the application can be realized by hardware, software or combination of software and hardware. The present disclosure may be implemented in a centralized manner in at least one computer system or in a decentralized manner by different parts distributed in several interconnected computer systems. Any computer system or other equipment that can realize the method of the application is applicable. The combination of commonly used software and hardware can be a general-purpose computer system installed with computer programs, and the computer system can be controlled by installing and executing programs to make it run according to the method of the application.

The application can also be implemented through a computer program product, the program contains all the features that can realize the method of the application, and the method of the application can be realized when it is installed in a computer system. The computer program in this document refers to any expression of a set of instructions that can be written in any programming language, code or symbol. The instruction group enables the system to process information to directly realize a specific function, or after one or two of the following steps: a) convert to other languages, codes or symbols; b) reproduce in different formats.

Although the present disclosure is illustrated by specific embodiments, those skilled in the art should understand that various transformations and equivalent substitutions can be made to the disclosure without departing from the scope of the present disclosure. In addition, various modifications can be made to the present disclosure for specific situations or materials without departing from the scope of the disclosure. Therefore, the disclosure is not limited to the specific embodiments disclosed, but should include all the embodiments falling within the scope of the claims of the disclosure.

The above disclosure is just preferable embodiments and does not limit the present disclosure. Any modification, equivalent replacement and improvement made within the spirit and principle of the present disclosure shall be included in the protection scope of the present disclosure.

1. A system for isolated management of digital assets comprising a financial management server communicating with an external network, a management server communicating with the financial management server through a first communication channel, a key server communicating with the management server through a second communication channel, and a first offline encryption machine communicating with the key server through a third communication channel;
wherein the financial management server receives a key application and transmits the key application to the key server through the management server, the key server generates a key and transmits the key to the first offline encryption machine; wherein the first offline encryption machine encrypts the key to generate an encrypted private key and a public key, stores the encrypted private key internally and returns the public key to the key server which further returns the public key to the financial management server along an original path.

2. The system for isolated management of digital assets according to claim 1, wherein the financial management server receives a transaction data to be signed and transmits it to the key server through the management server; the key server encrypts the transaction data to be signed with the public key and transmits encrypted data to the first offline encryption machine, wherein the first offline encryption machine signs the encrypted data with the encrypted private key and then returns a signature data to the key server which returns the signature data to the financial management server along the original path.

3. The system for isolated management of digital assets according to claim 2, wherein the third communication channel includes a first acoustic transceiver arranged on the key server and a second acoustic transceiver arranged on the first offline encryption machine; wherein the first acoustic transceiver is connected with the key server through a USB interface, and the second acoustic transceiver is connected with the first offline encryption machine through a USB interface.

4. The system for isolated management of digital assets according to claim 2, wherein the third communication channel includes a first QR code scanning communication device arranged on the key server and a second QR code scanning communication device arranged on the first offline encryption machine, wherein the first QR code scanning communication device is communicated with the key server through a USB interface, and the second QR code scanning communication device is communicated with the first offline encryption machine through a USB interface; wherein each QR code scanning communication device comprises a scanning unit and a display unit respectively.

5. The system for isolated management of digital assets according to claim 4, wherein the financial management server receives the transaction data to be signed and transmits it to the key server through the management server; the key server encodes the transaction data to be signed to obtain a QR code and then encrypts obtained QR code with the public key and displays encrypted QR code on its corresponding display unit, the first offline encryption machine scans the encrypted QR code to obtain the transaction data through its corresponding scanning unit and signs the transaction data with the encrypted private key, then encodes signature data to obtain a signature QR code and displays the signature QR code on its corresponding display unit; the key server scans the signature QR code through its corresponding scanning unit to obtain the signature data and then returns the signature data to the financial management server along the original path.

6. The system for isolated management of digital assets according to claim 1, wherein the system for isolated management of digital assets comprises a plurality of first offline encryption machines, wherein the financial management server receives a key application and transmits the key application to the key server through the management server, the key server generates a key and transmits the key to each first offline encryption machine; wherein each first offline encryption machine encrypts the key to generate respective encrypted private key and public key, stores the respective encrypted private key internally and returns the respective public key to the key server which further returns the respective public key to the financial management server along an original path.

7. The system for isolated management of digital assets according to claim 6, wherein the financial management server receives a transaction data to be signed and transmits it to the key server through the management server; the management server selects at least one first offline encryption machine from the plurality of first offline encryption machines to sign the transaction data according to a scheduled rule.

8. (canceled)

9. (canceled)

10. The system for isolated management of digital assets according to claim 2, wherein the system for isolated management of digital assets further comprises a second offline encryption machine communicating with the first offline encryption machine through a fourth communication channel.

11. The system for isolated management of digital assets according to claim 10, wherein the financial management server receives a key application and transmits the key application to the key server through the management server, the key server generates a key and transmits the key to the first offline encryption machine which forwards the key to the second offline encryption machine; wherein the second offline encryption machine encrypts the key to generate an encrypted private key and public key, stores the encrypted private key internally and returns the public key to the financial management server along the original path;
wherein the financial management server receives a transaction data to be signed and transmits it to the key server through the management server; the key server forwards the transaction data to be signed to the first offline encryption machine which encrypts the transaction data to be signed with the public key and transmits encrypted data to the second offline encryption machine, wherein the second offline encryption machine signs the encrypted data with the encrypted private key and then returns a signature data to the financial management server along the original path.

12. The system for isolated management of digital assets according to claim 11, wherein the first offline encryption machine and the second offline encryption machine are arranged in a closed space and the key server is arranged outside the closed space;
wherein the third communication channel includes a first acoustic transceiver arranged on the key server and a second acoustic transceiver arranged on the first offline encryption machine; wherein the first acoustic transceiver is connected with the key server through a USB interface, and the second acoustic transceiver is connected with the first offline encryption machine through a USB interface;
the fourth communication channel includes a first QR code scanning communication device arranged on the first offline encryption machine and a second QR code scanning communication device arranged on the second offline encryption machine, wherein the first QR code scanning communication device is communicated with the first offline encryption machine through a USB interface, and the second QR code scanning communication device is communicated with the second offline encryption machine through a USB interface; wherein each QR code scanning communication device comprises a scanning unit and a display unit respectively.

13. (canceled)

14. (canceled)

15. The system for isolated management of digital assets according to claim 12, wherein the financial management server receives the transaction data to be signed from an external network and transmits it to the key server through the management server;
the key server transmits the transaction data to be signed to the second acoustic transceiver corresponding to the first offline encryption machine through the first acoustic transceiver;
wherein the first offline encryption machine encodes the transaction data to be signed to obtain a QR code and then encrypts obtained QR code with the public key and displays encrypted QR code on its corresponding display unit, the second offline encryption machine scans the encrypted QR code to obtain the transaction data through its corresponding scanning unit and signs the transaction data with the encrypted private key, then encodes signature data to obtain a signature QR code and displays the signature QR code on its corresponding display unit; wherein the first offline encryption machine scans the signature QR code through its corresponding scanning unit to obtain the signature data and transmits the signature data through the second acoustic transceiver; wherein the key server receives the signature data through the first acoustic transceiver and returns the signature data to the financial management server along the original path.

16. The system for isolated management of digital assets according to claim 2, wherein the system for isolated management of digital assets comprises a plurality of second offline encryption machines, wherein the financial management server receives a key application and transmits the key application to the key server through the management server, the key server generates a key and transmits the key to each second offline encryption machine through the first offline encryption machine; wherein each second offline encryption machine encrypts the key to generate respective encrypted private key and public key, stores the respective encrypted private key internally and returns the respective public key to the key server which further returns the respective public key to the financial management server along the original path.

17. The system for isolated management of digital assets according to claim 16, wherein the financial management server receives the transaction data to be signed and transmits it to the key server through the management server; the management server selects at least one second offline encryption machine from the plurality of second offline encryption machines to sign the transaction data according to a scheduled rule.

18. The system for isolated management of digital assets according to claim 1, wherein the system for isolated management of digital assets further comprises a wallet server and an online encryption machine; wherein the wallet server is communicating with the financial management server through the first communication channel and with the key server through the second communication channel, wherein the wallet server is further communicating with the online encryption machine at the same time;
wherein the wallet server receives a digital asset storage request and stores a first proportion of digital assets into the online encryption machine and a second proportion of digital assets into the first offline encryption machine according to a scheduled rule;
the financial management server receives a digital asset retrieval request and transmits it to the wallet server which retrieves the digital assets from the online encryption machine and/or the first offline encryption machine according to the scheduled rule and returns the digital assets to the financial management server.

19. The system for isolated management of digital assets according to claim 18, wherein the financial management server receives a key application and transmits the key application to the key server through the management server, the key server generates a key and transmits the key to the first offline encryption machine and the online encryption machine;
wherein the online encryption machine encrypts the key to generate a first encrypted private key and a first public key, stores the first encrypted private key internally and returns the first public key to the key server and the financial management server; wherein the first offline encryption machine encrypts the key to generate a second encrypted private key and a second public key, stores the second encrypted private key internally and returns the second public key to the key server which further returns the second public key to the financial management server.

20. The system for isolated management of digital assets according to claim 19, wherein the wallet server parses out a first transaction data to be signed by the online encryption machine and/or a second transaction data to be signed by the first offline encryption machine based on the digital asset retrieval request and the scheduled rule; the key server encrypts the first transaction data with the first public key and transmits a first encrypted data to the online encryption machine through the wallet server, the online encryption machine signs the first encrypted data with the first encrypted private key, and then returns generated first signature data to the wallet server which returns the first signature data to the financial management server along the original path; wherein the key server encrypts the second transaction data with the second public key and transmits a second encrypted data to the first offline encryption machine through the third communication channel, the first offline encryption machine signs the second encrypted data with the second encrypted private key and then returns a second signature data to the key server which returns the second signature data to the financial management server along the original path.

21. The system for isolated management of digital assets according to claim 10, wherein the system for isolated management of digital assets further comprises a wallet server and an online encryption machine; wherein the wallet server is communicating with the financial management server through the first communication channel and with the key server through the second communication channel, wherein the wallet server is further communicating with the online encryption machine at the same time;
wherein the wallet server receives a digital assets storage request and stores a first proportion of digital assets into the online encryption machine and a second proportion of digital assets into the second offline encryption machine according to a scheduled rule;
the financial management server receives a digital asset retrieval request and transmits it to the wallet server which retrieves the digital assets from the online encryption machine and/or the second offline encryption machine according to the scheduled rule and returns the digital assets to the financial management server.

22. The system for isolated management of digital assets according to claim 21, wherein the financial management server receives a key application and transmits the key application to the key server through the management server, the key server generates a key and transmits the key to the first offline encryption machine and the online encryption machine; wherein the online encryption machine encrypts the key to generate a first encrypted private key and a first public key, stores the first encrypted private key internally and returns the first public key to the key server and the financial management server; wherein the first offline encryption machine forwards the key to the second offline encryption machine which encrypts the key to generate a second encrypted private key and a second public key, stores the second encrypted private key internally and returns the second public key to the first offline encryption machine, then the first offline encryption machine further returns the second public key to the financial management server.

23. The system for isolated management of digital assets according to claim 22, wherein the wallet server parses out a first transaction data to be signed by the online encryption machine and/or a second transaction data to be signed by the second offline encryption machine based on the digital asset retrieval request and the scheduled rule; wherein the key server encrypts the first transaction data with the first public key and transmits a first encrypted data to the online encryption machine through the wallet server, the online encryption machine signs the first encrypted data with the first encrypted private key, and then returns generated first signature data to the wallet server which returns the first signature data to the financial management server along the original path; wherein the key server forwards the second transaction data to the first offline encryption machine which encrypts the second transaction data with the second public key and transmits a second encrypted data to the second offline encryption machine through the fourth communication channel, the second offline encryption machine signs the second encrypted data with the second encrypted private key and then returns a second signature data to the first offline encryption machine which returns the second signature data to the financial management server along the original path.

24. The system for isolated management of digital assets according to claim 18, wherein the wallet server firstly determines whether total digital assets stored in the online encryption machine meets the digital asset retrieval request; if yes, the digital assets are retrieved from the online encryption machine and returned to the financial management server; or lese, first digital assets are retrieved from the online encryption machine and second digital assets are retrieved from the first or second offline encryption machine and then returned to the financial management server; wherein a sum of the first digital assets and the second digital assets is greater than or equal to the digital asset retrieval request.

25. (canceled)

26. (canceled)

27. (canceled)

28. (canceled)
